(19) United States
(12) Patent Application Publication
(10) Pub. No.: US 2025/0214638 A1
(43) Pub. Date: Jul. 3, 2025

(54) SMART STROLLER

(71) Applicant: New Century Products Co., Ltd., Taipei City (TW)

(72) Inventor: Fu-Tsun LIN, Taipei City (TW)

(21) Appl. No.: 18/420,727

(22) Filed: Jan. 23, 2024

(30) Foreign Application Priority Data
Dec. 27, 2023 (CN) 202311823429.6

(51) Int. Cl. B62B 5/00; B62B 9/08; H04N 7/18; H04W 4/029

(52) U.S. Cl. CPC B62B 5/0069; B62B 5/004; B62B 9/082; H04N 7/185; H04W 4/029

(57) ABSTRACT

Provided is a smart stroller including a stroller, master control module and power control module. The stroller includes a chassis support, a front wheel support which two front wheels are disposed at, a rear wheel support which two rear wheels are disposed at, a seat, handle, guardrail and canopy. The master control module is disposed on a base of the handle of the stroller. The master control module includes a controller, brake controller, first wireless communication device, and global positioning system. The power control module is disposed at the bottom of the rear wheel support and includes a second wireless communication module, power source module, foot brake component, drive motor, deceleration mechanism, and drive controller. The smart stroller is applicable to a global positioning system and an anti-theft system and capable of performing video surveillance, automatic braking, music playing and storytelling to ensure user safety and captivating user experience.

### TECHNICAL FIELD OF THE INVENTION

The present disclosure relates to smart strollers, and more particularly to a smart stroller integrated with a mobile app to ensure user safety and captivating user experience.

### BACKGROUND

Families with babies and toddlers usually own strollers to not only dispense with the hassles of carrying the babies and toddlers but also allow the babies and toddlers to sit safely and comfortably in the strollers. Commercially-available strollers come in a wide variety of types. From the perspective of frame structures, a variety of collapsible strollers is available to consumers. From the perspective of constituent parts, lightweight strollers are almost like chairs, but high-end strollers are each equipped with parts, such as a handle, canopy, snack tray, and storage basket. However, the aforesaid strollers have a drawback: they are not self-powered and thus must be pushed forward and pulled backwards by hand.

With ever advancing technology, research on smart strollers is becoming more innovative. Every existing smart stroller comes with a plurality of sensors capable of performing different sensing functions, including sensing the body weight of the baby or toddler sitting in the stroller. A display screen mounted on the handle of the stroller displays the body weight thus sensed as well as the stroller's speed and mileage, and ambient temperature. The aforesaid data is wirelessly sent to a mobile app of an electronic device in the possession of the baby's or toddler's parents. However, existing smart strollers fail to enable parents to monitor babies and toddlers sitting in the strollers, the surroundings, and the usage of the strollers, rending it impossible to confirm the safety of the babies and toddlers in the strollers.

In view of the aforesaid drawback of the prior art, the inventor of the disclosure conceived room for improvement in the prior art and thus conducted extensive researches and experiments according to the inventor's years of experience in the related industry, and finally devised a smart stroller as disclosed in the disclosure.

### SUMMARY OF THE INVENTION

In view of the aforesaid drawback of the prior art, it is an objective of the disclosure to provide a smart stroller integrated with a mobile app and adapted to not only use a camera lens to carry out video surveillance on a baby or toddler sitting in the stroller and road conditions ahead but also use the mobile app to remotely control the stroller. The smart stroller of the disclosure has a fingerprint recognition unit for identifying a user of the smart stroller starting to be used, so as to achieve an anti-theft purpose. Moreover, the smart stroller of the disclosure records the usage time, usage frequency, and usage state of the smart stroller. Furthermore, the smart stroller of the disclosure has an automatic brake mechanism, global positioning system, pressure sensor and tilt sensor to enhance user safety of the smart stroller. Furthermore, an alert unit of the smart stroller of the disclosure not only generates vibration or an alert sound to remind the user to pay attention to the stroller but also performs music playing and storytelling to enhance user experience.

To achieve the above and other objectives, the disclosure provides a smart stroller comprising a stroller, a master control module and a power control module. The stroller comprises a chassis support, a front wheel support, a rear wheel support, a seat, a handle, a guardrail and a canopy. The bottom of the chassis support is connected to the front wheel support and the rear wheel support. A front right wheel and a front left wheel are disposed at the bottom of the front wheel support. A rear right wheel and a rear left wheel are disposed at the bottom of the rear wheel support. The rear end of the chassis support is connected to the handle. The seat is mounted on the chassis support. The guardrail is disposed at the front end of the seat. The canopy is disposed at the upper end of the seat. The master control module is disposed on a base of the handle of the stroller. The master control module comprises a controller, a brake controller and a first wireless communication device. The controller is electrically connected to the brake controller and the first wireless communication device. The brake controller is adapted to control at least one drive motor and at least one brake gear of the stroller. The first wireless communication device is in communication connection with a portable electronic device by a wireless means. Furthermore, the power control module is disposed at the bottom of the rear wheel support. The power control module comprises a second wireless communication module, a power source module, a foot brake component, at least one drive motor, a deceleration mechanism, a drive controller and a motor driving board. The power source module is electrically connected to the second wireless communication module and the master control module. The power control module is in wireless communication with the master control module and the portable electronic device through the second wireless communication module. At least one brake gear is fixed to the tire of the rear right wheel and the tire of the rear left wheel respectively and rotates at the same speed as the tires. A plurality of dogs are disposed on the circumferential side of each brake gear. The foot brake component is swingable downward and has two sides each provided with a clutching element for clutching the dogs as soon as the user steps on the foot brake component, stopping rotation of the rear right wheel and the rear left wheel. The smart stroller further comprises a tilt sensor mounted in place inside the rear right wheel and the rear left wheel to sense an inclination of the stroller and send the inclination thus sensed to the controller, allowing the controller to determine whether to send a brake signal to the brake controller according to the inclination to stop the stroller whenever the stroller has not been braked with the foot brake component. The smart stroller further comprises a camera lens disposed on the guardrail of the stroller, being a fisheye camera lens in communication connection with the controller, and adapted to capture a plurality of images of surroundings of the stroller and wirelessly send the images to the portable electronic device to monitor the surroundings of the stroller.

The disclosure is hereunder illustrated by a preferred embodiment and depicted by drawings with reference numerals to explain the technical features, advantages and achievable functions of the disclosure.

### BRIEF DESCRIPTION OF THE DRAWINGS

FIG. 1 is a perspective view of a smart stroller of the disclosure.

FIG. 2 is a block diagram of a master control module and a power control module of the smart stroller of the disclosure.

FIG. 3 is a perspective view of the power control module of the smart stroller of the disclosure.

FIG. 4 is a schematic view of the master control module of the smart stroller of the disclosure.

FIG. 5 is a schematic view of the smart stroller of the disclosure and a portable electronic device.

### DETAILED DESCRIPTION OF THE PREFERRED EMBODIMENTS

The implementation of the disclosure is herein illustrated by specific embodiments. Persons skilled in the art can refer to the description presented herein to easily gain insight into the other advantages and functions of the disclosure. Furthermore, the disclosure can be implemented or applied according to any other variant, specific embodiments and may be modified and changed in various ways without departing from the spirit of the disclosure.

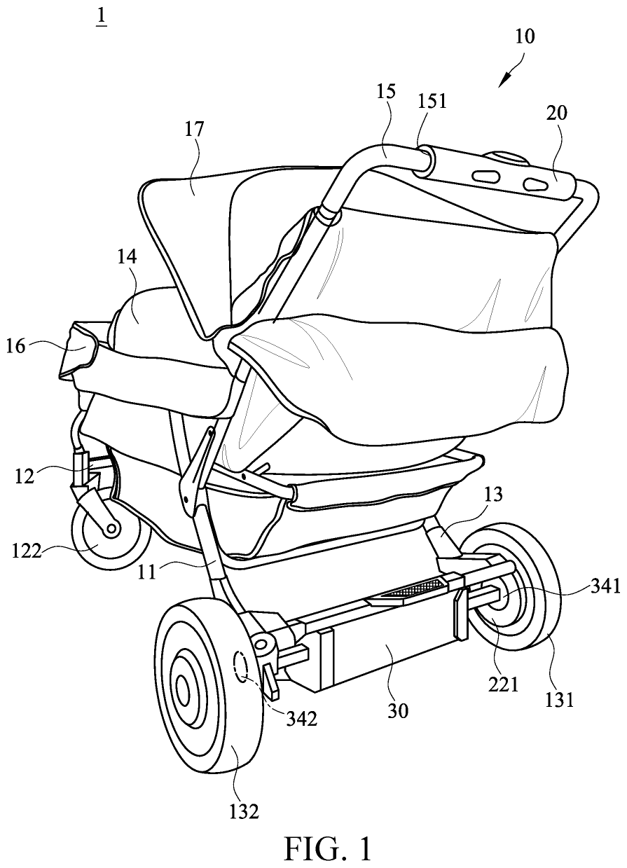

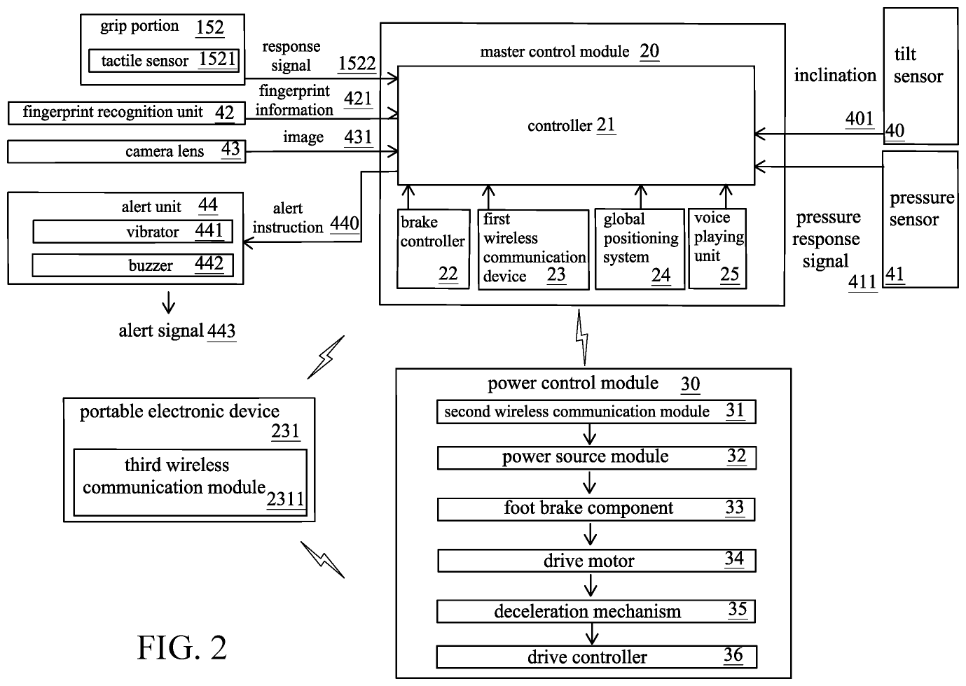

Referring to FIG. 1 and FIG. 2, the disclosure provides a smart stroller 1 comprises a stroller 10, a master control module 20 and a power control module 30. The stroller 10 comprises a chassis support 11, a front wheel support 12, a rear wheel support 13, a seat 14, a handle 15, a guardrail 16 and a canopy 17. The bottom of the chassis support 11 is connected to the front wheel support 12 and the rear wheel support 13. A front right wheel (not shown) and a front left wheel 122 are disposed at the bottom of the front wheel support 12. A rear right wheel 131 and a rear left wheel 132 are disposed at the bottom of the rear wheel support 13. The rear end of the chassis support 11 is connected to the handle 15. The seat 14 is mounted on the chassis support 11. The guardrail 16 is disposed at the front end of the seat 14. The canopy 17 is disposed at the upper end of the seat 14. The master control module 20 is disposed on a base 151 of the handle 15 of the stroller 10. The master control module 20 comprises a controller 21, a brake controller 22, a first wireless communication module 23 and a global positioning system 24. The controller 21 is electrically connected to the brake controller 22, the first wireless communication module 23 and the global positioning system 24. The brake controller 22 is adapted to control at least one brake gear 221 and at least one drive motor 34 of the stroller 10. At least one drive motor 34 comprises a rear right wheel motor 341 and a rear left wheel motor 342. The rear right wheel motor 341 is disposed in a right hub of the rear right wheel 131. The rear left wheel motor 342 is disposed in a left hub of the rear left wheel 132. The first wireless communication module 23 is in communication connection with a portable electronic device 231 by a wireless means. The wireless means is one of Bluetooth protocol, wireless network protocol, wireless RF communication, broadband network communication, Zigbee, Thread, 3G protocol and 4G protocol. The global positioning system 24 sends a position information to the portable electronic device 231 through the first wireless communication module 23 to confirm the position of the stroller 10.

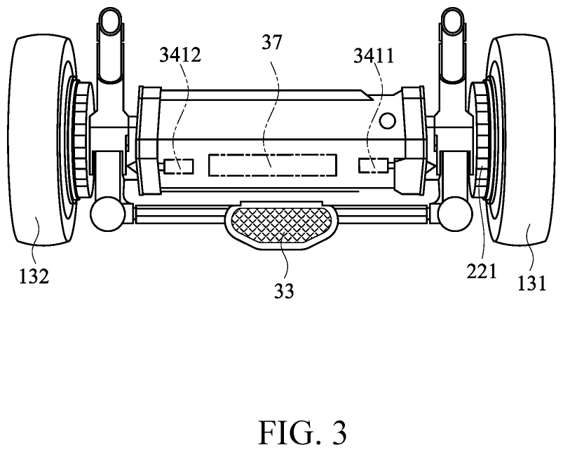

Referring to FIG. 2 and FIG. 3, the power control module 30 is disposed at the bottom of the rear wheel support 13 and comprises a second wireless communication module 31, a power source module 32, a foot brake component 33, the rear right wheel motor 341 and the rear left wheel motor 342, two deceleration mechanisms 35, two drive controllers 36 and a motor driving board 37. The power source module 32 is electrically connected to the second wireless communication module 31 and the master control module 20; alternatively, the master control module 20 operates in conjunction with a self-contained power source module that supplies independent power to the master control module 20. The power control module 30 is in wireless communication connection with the master control module 20 and the portable electronic device 231 through the second wireless communication module 31. The foot brake component 33 is disposed between the rear right wheel 131 and the rear left wheel 132. The rear right wheel motor 341 and the rear left wheel motor 342 outputs rotational speed and outputs torque. The two deceleration mechanisms 35 are connected to the rear right wheel motor 341 and the rear left wheel motor 342 respectively. The two deceleration mechanisms 35 change the output rotational speed and output torque of the rear right wheel motor 341 and the rear left wheel motor 342. The two drive controllers 36 are connected to the rear right wheel motor 341 and the rear left wheel motor 342. The rear right wheel motor 341 is connected to the motor driving board 37 through a motor right signal line 3411. The rear left wheel motor 342 is connected to the motor driving board 37 through a motor left signal line 3412. The two brake gears 221 are fixed in place inside the tire of the rear right wheel 131 and the tire of the rear left wheel 132 respectively and rotate at the same speed as the tires. A plurality of dogs are disposed on the circumferential side of each brake gear 221. The foot brake component 33 is swingable downward and has two sides each provided with a clutching element. When the user steps on the foot brake component 33 with a view to braking the smart stroller 1, the clutching elements clutch the dogs and thus stop the rear right wheel 131 and the rear left wheel 132 from rotating. Furthermore, the smart stroller 1 further comprises a tilt sensor 40 and a pressure sensor 41. The tilt sensor 40 is mounted in place inside the rear right wheel 131 and the rear left wheel 132. The tilt sensor 40 senses and sends an inclination 401 of the stroller 10 to the controller 21. The controller 21 determines whether to send a brake signal to the brake controller 22 according to the inclination 401 to stop the stroller 10 whenever the stroller 10 has not been braked with the foot brake component 33. When the controller 21 receives the inclination 401 and determines that the inclination 401 is an uphill inclination, the power control module 30 increases the electric current supplied to the drive motor 34 and thus allows the stroller 10 to move uphill at a higher speed. The pressure sensor 41 is disposed on the seat 14 to sense the body weight of a baby or toddler sitting in the stroller 10 and thus send a pressure response signal 411 to the controller 21. If the controller 21 does not receive the pressure response signal 411 from the pressure sensor 41, the controller 21 will send an alert instruction 440 to an alert unit 44 to cause the alert unit 44 to generate an alert signal 443. The alert unit 44 is a vibrator 441 or a buzzer 442 mounted on the stroller 10. The alert signal 443 is vibration or an alert sound. Furthermore, the master control module 20 further comprises a voice playing unit 25. The voice playing unit 25 sends a voice signal to the controller 21. The controller 21 sends the voice signal to the buzzer 442 through the first wireless communication module 23 and plays the voice signal with the buzzer 442. The voice signal comprises music or audio stories.

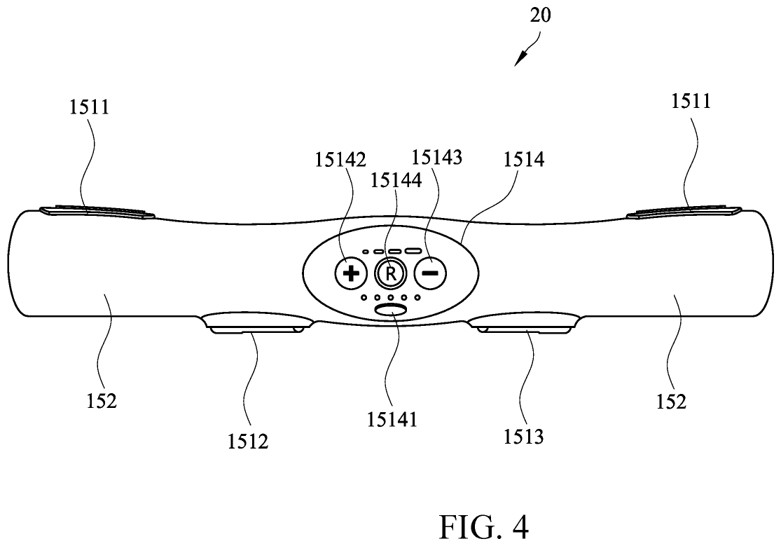

Referring to FIG. 2 and FIG. 4, a grip portion 152 with a tactile sensor 1521 is disposed on the master control module 20, and the controller 21 is electrically connected to the tactile sensor 1521. When the user touches the grip portion 152, the tactile sensor 1521 generates and sends a response signal 1522 to the controller 21 to cause the controller 21 to instruct the brake controller 22 to disengage the two brake gears 221 from the rear right wheel 131 and the rear left wheel 132. When the user stops touching the grip portion 152, the tactile sensor 1521 does not generate the response signal 1522, and thus the controller 21 instructs the brake controller 22 to cause the two brake gears 221 to engage with the rear right wheel 131 and the rear left wheel 132. The master control module 20 disposed on the handle 15 comprises two start buttons 1511, a left turn button 1512, a right turn button 1513 and a controlling module 1514. The positions of the two start buttons 1511, the left turn button 1512 and the right turn button 1513 are subject to changes as needed. For example, the two start buttons 1511 are disposed at the front end of the master control module 20, whereas the left turn button 1512 and the right turn button 1513 are disposed on two opposing sides of the two start buttons 1511 respectively, but the disclosure is not limited thereto. The controlling module 1514 is disposed above the master control module 20. The master control module 20 has a built-in circuit board (not shown) electrically connected to the drive controller 36 and the power source module 32. Each start button 1511 has a fingerprint recognition unit 42 for capturing a fingerprint information 421. The controller 21 determines whether the fingerprint information 421 matches a stored fingerprint information and generates a disengagement instruction when the determination is affirmative. The controlling module 1514 has a power source button 15141, an acceleration button 15142, a deceleration button 15143 and a reversing button 15144. The left turn button 1512, the right turn button 1513, the acceleration button 15142, the deceleration button 15143 and the reversing button 15144 are for use in controlling the direction of the rotation of the drive motor 34 to drive the stroller 10 moving forward, reversing or turning. The controlling module 1514 is a touchscreen or a display screen.

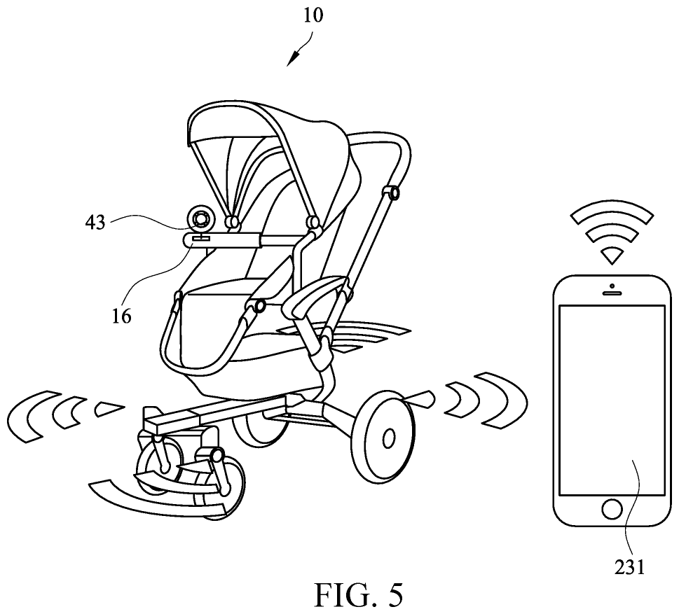

Referring to FIG. 2 and FIG. 5, the smart stroller 1 further comprises a camera lens 43. The camera lens 43 is disposed on the guardrail 16 of the stroller 10. The camera lens 43 is a fisheye camera lens in communication connection with the controller 21. The camera lens 43 captures a plurality of images 431 of the surroundings of the stroller 10 and wirelessly sends the images 431 to the portable electronic device 231 to monitor the surroundings of the stroller 10.

The aforesaid embodiment merely serves illustrative, exemplary purposes. The scope of the claims of the disclosure shall be defined by the appended claims but not restricted to the aforesaid embodiment.

What is claimed is:

1. A smart stroller, comprising:
a stroller comprising a chassis support, a front wheel support, a rear wheel support, a seat, a handle, a guardrail and a canopy, wherein a bottom of the chassis support is connected to the front wheel support and the rear wheel support, a front right wheel and a front left wheel are disposed at a bottom of the front wheel support, a rear right wheel and a rear left wheel are disposed at a bottom of the rear wheel support, a rear end of the chassis support is connected to the handle, the seat is mounted on the chassis support, the guardrail is disposed at a front end of the seat, and the canopy is disposed at an upper end of the seat;
a master control module disposed on a base of the handle of the stroller and comprising a controller, a brake controller and a first wireless communication device, with the controller electrically connected to the brake controller and the first wireless communication device, the brake controller adapted to control at least a drive motor and at least a brake gear of the stroller, and the first wireless communication device adapted to be in communication connection with a portable electronic device by a wireless means; and
a power control module disposed at a bottom of the rear wheel support and comprising a second wireless communication module, a power source module, a foot brake component, the at least a drive motor, a deceleration mechanism, a drive controller and a motor driving board, with the power source module electrically connected to the second wireless communication module and the master control module, the power control module being in wireless communication connection with the master control module and the portable electronic device through the second wireless communication module, wherein at least a drive motor outputs rotational speed and outputs torque, the deceleration mechanism is connected to at least a drive motor, the output rotational speed and output torque of at least a drive motor are changed by the deceleration mechanism, and the drive controller is connected to at least a drive motor and the motor driving board,
wherein at least a brake gear is fixed to a tire of the rear right wheel and a tire of the rear left wheel respectively and rotates at a same speed as the tires, with a plurality of dogs disposed on a circumferential side of each said brake gear, wherein the foot brake component is swingable downward and has two sides each provided with a clutching element for clutching the dogs as soon as the user steps on the foot brake component, stopping rotation of the rear right wheel and the rear left wheel;
a tilt sensor mounted in place inside the rear right wheel and the rear left wheel to sense an inclination of the stroller and send the inclination thus sensed to the controller, allowing the controller to determine whether to send a brake signal to the brake controller according to the inclination to stop the stroller whenever the stroller has not been braked with the foot brake component; and
a camera lens disposed on the guardrail of the stroller, being a fisheye camera lens in communication connection with the controller, and adapted to capture a plurality of images of surroundings of the stroller and wirelessly send the images to the portable electronic device to monitor the surroundings of the stroller.

2. The smart stroller of claim 1, wherein at least a drive motor comprises a rear right wheel motor disposed in a right hub of the rear right wheel and connected to the motor driving board by a motor right signal line, and a rear left wheel motor disposed in a left hub of the rear left wheel and connected to the motor driving board by a motor left signal line.

3. The smart stroller of claim 1, wherein the tilt sensor sends the inclination thus sensed to the controller, wherein, when the stroller has not been braked with the foot brake component, the power control module increases electric current supplied to the drive motor as soon as the controller determines that the inclination is an uphill inclination, allowing the stroller to move uphill at a higher speed.

4. The smart stroller of claim 1, wherein a grip portion with a tactile sensor is disposed on the master control module, and the controller is electrically connected to the tactile sensor, wherein, when the user touches the tactile sensor, the tactile sensor sends a response signal to the controller to cause the controller to instruct the brake controller to disengage the brake gears from the rear right wheel and the rear left wheel, wherein, when the user stops touching the grip portion, the tactile sensor does not generate the response signal, and thus the controller instructs the brake controller to cause the two brake gears to engage with the rear right wheel and the rear left wheel.

5. The smart stroller of claim 1, wherein the master control module further comprises a global positioning system electrically connected to the controller, and the first wireless communication device sends a position information to the portable electronic device to confirm a position of the stroller.

6. The smart stroller of claim 1, wherein the wireless means is one of Bluetooth protocol, wireless network protocol, wireless RF communication, broadband network communication, Zigbee, Thread, 3G protocol and 4G protocol.

7. The smart stroller of claim 1, further comprising a pressure sensor disposed on the seat to sense a weight and thus send a pressure response signal to the controller, wherein, if the controller does not receive the pressure response signal from the pressure sensor, the controller will send an alert instruction to an alert unit to cause the alert unit to generate an alert signal.

8. The smart stroller of claim 7, wherein the alert unit is a vibrator or a buzzer mounted on the stroller, and the alert signal is vibration or an alert sound.

9. The smart stroller of claim 1, further comprising two start buttons disposed on the master control module, each of the two start buttons has a fingerprint recognition unit for capturing a fingerprint information, and the controller determines whether the fingerprint information matches a stored fingerprint information and generates a disengagement instruction when the determination is affirmative.
